(19) United States
(12) Patent Application Publication
(10) Pub. No.: US 2019/0022835 A1
(43) Pub. Date: Jan. 24, 2019

(54) SOCKET WITH FASTENER HOLDING AND EASILYREMOVING STRUCTURE

(71) Applicant: Chia-Lin Chen, Taichung City (TW)

(72) Inventor: Chia-Lin Chen, Taichung City (TW)

(21) Appl. No.: 16/143,413

(22) Filed: Sep. 26, 2018

(30) Foreign Application Priority Data
Jan. 6, 2016 (TW) 105100265

(51) Int. Cl. B25B 23/12; B25B 13/06; B25B 23/00

(52) U.S. Cl. CPC B25B 23/12; B25B 23/0057; B25B 13/06

(57) ABSTRACT

A socket contains: a body, a push member, and a reverse pushing structure. The body includes a connecting section and a fitting section, the connecting section has a first polygonal orifice configured to accommodate a socket wrench, and the fitting section has a second polygonal orifice for driving a fastener element. The body includes a receiving groove defined therein communicating with the second polygonal orifice, and the push member is movably accommodated in the second polygonal orifice and includes at least one magnetic attraction element. The reverse pushing structure is housed in the receiving groove and configured to push the push member toward the rim of the second polygonal orifice.

### FIELD OF THE INVENTION

The present invention relates to a socket which contains the reverse pushing structure configured to magnetically attract the fastener element securely and to pushes out and holds the fastener element on the rim of the socket. So that the fastener element can be taken out from the socket easily.

### BACKGROUND OF THE INVENTION

Sockets are used for driving fasteners, e.g., nuts and screws having a polygonal-shaped head that can be applicable for building construction, car repair, maintenance, or furniture assembly.

However, the screw bolt or the nut normally drops off from the socket, making it hard to pick up when working at a narrow space. Sometimes, it also happens that the nut stuck inside the socket and were hard to remove.

The present invention has arisen to mitigate or obviate the afore-described disadvantages.

### SUMMARY OF THE INVENTION

The primary aspect of the present invention is to a socket which contains the reverse pushing structure configured to magnetically attract the fastener element and to push the fastener element out of the socket easily.

To obtain the above-mentioned aspect, a socket provided by the present invention contains: a body, a push member, and a reverse pushing structure.

The body includes a connecting section and a fitting section, the connecting section has a first polygonal orifice configured to accommodate a socket wrench, and the fitting section has a second polygonal orifice for driving a fastener element.

The body further includes a receiving groove defined therein communicating with the second polygonal orifice, and the push member is movably accommodated in the second polygonal orifice and includes at least one magnetic attraction element.

The reverse pushing structure is housed in the receiving groove and configured to push the push member toward the second polygonal orifice rim.

Preferably, the reverse pushing structure includes a retainer and a spring, the retainer is housed in the receiving groove, and two ends of the spring are connected with the retainer and the push member.

Preferably, the push member is polygonal fitting to the first polygonal orifice so as to avoid a rotation of the push member.

Likewise, the reverse pushing structure which is a first magnet, the first magnet is accommodated in the receiving groove and magnetically repels against the magnetic attraction element embedded in the push member, the push member includes a second magnet magnetically attracted on an inner wall of the second polygonal orifice, wherein a magnetic repulsion force between the first magnet and the magnetic attraction element is more than a magnetic attraction force of the second magnet, and when the push member is pushed by the magnetic repulsion force to move onto the rim of the second polygonal orifice, a magnetic attraction force between the second magnet and the second polygonal orifice is more than the magnetic repulsion force between the first magnet and the magnetic attraction element and a magnetic attraction force between the magnetic attraction element and the fastener element.

### BRIEF DESCRIPTION OF THE DRAWINGS

FIG. 1 is a perspective view showing the assembly of a socket according to a first embodiment of the present invention.

FIG. 2 is a cross-sectional perspective view showing the exploded components of the socket according to the first embodiment of the present invention.

FIG. 3 is a cross sectional view showing the operation of the socket according to the first embodiment of the present invention.

FIG. 4 is a cross sectional view showing the operation of the socket according to the first embodiment of the present invention.

FIG. 5 is a cross-sectional perspective view showing the exploded components of the socket according to a second embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

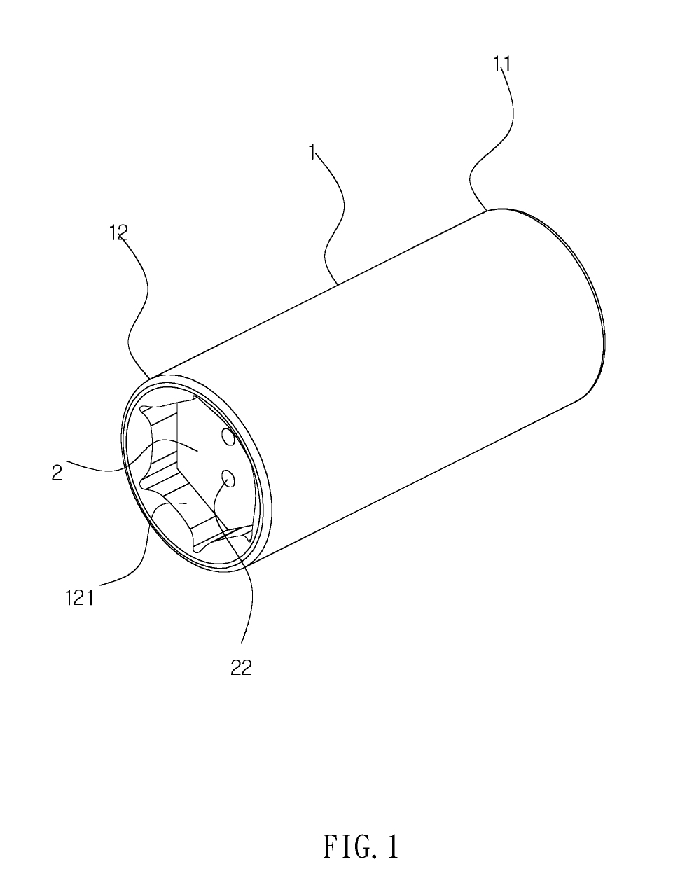

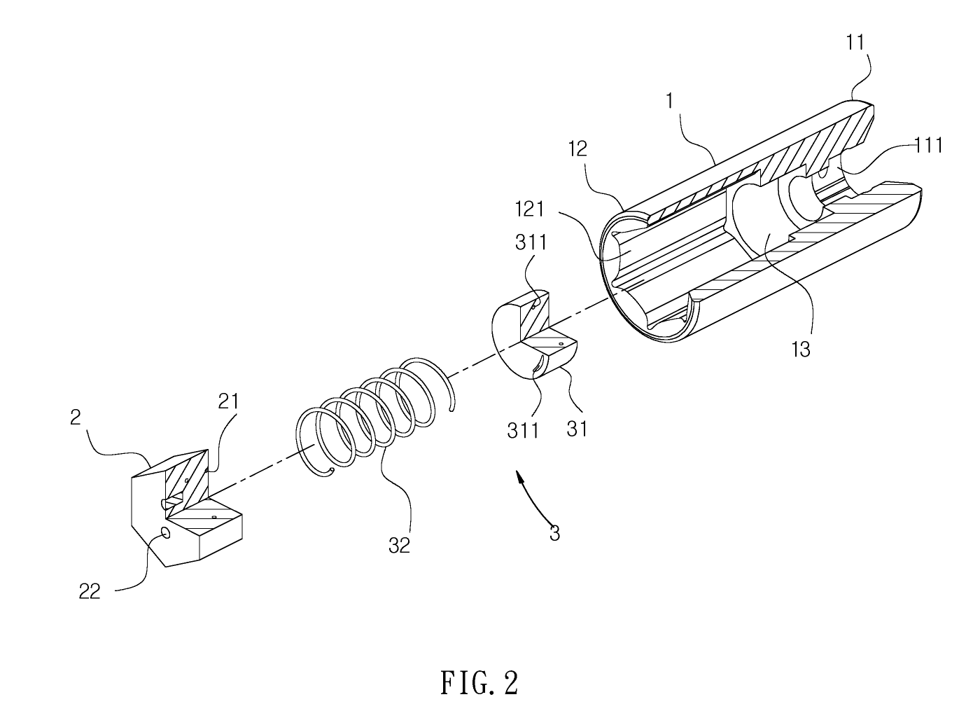

With reference to FIGS. 1-4, a socket in accordance with a first embodiment of the present invention comprises: a body 1, a push member 2, and a reverse pushing structure 3.

The body 1 includes a connecting section 11 and a fitting section 12, the connecting section 11 has a first polygonal orifice 111 configured to accommodate a socket wrench, and the fitting section 12 has a second polygonal orifice 121 for driving a fastener element. The body 1 includes a receiving groove 13 defined therein communicating with the second polygonal orifice 121. The push member 2 is movably accommodated in the second polygonal orifice 121 and includes at least one magnetic attraction element 22. The reverse pushing structure 3 is housed in the receiving groove 13 and pushes the push member 2 to close to the rim of the second polygonal orifice 121. The reverse pushing structure 3 includes a retainer 31 and a spring 32, wherein the retainer 31 is housed in the receiving groove 13, and two ends of the spring 32 are connected with the retainer 31 and the push member 2.

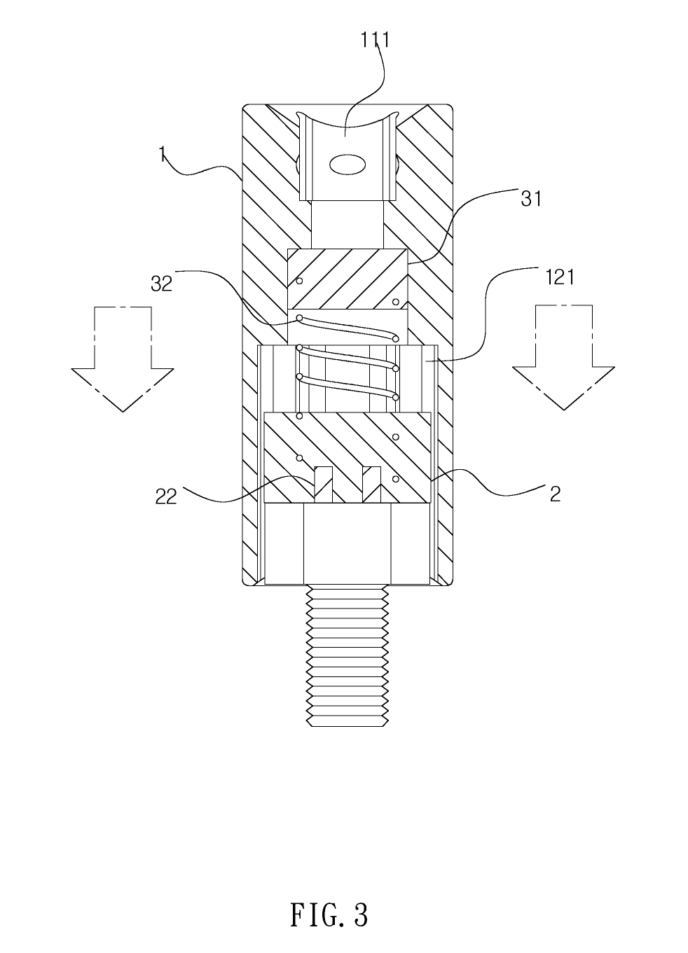

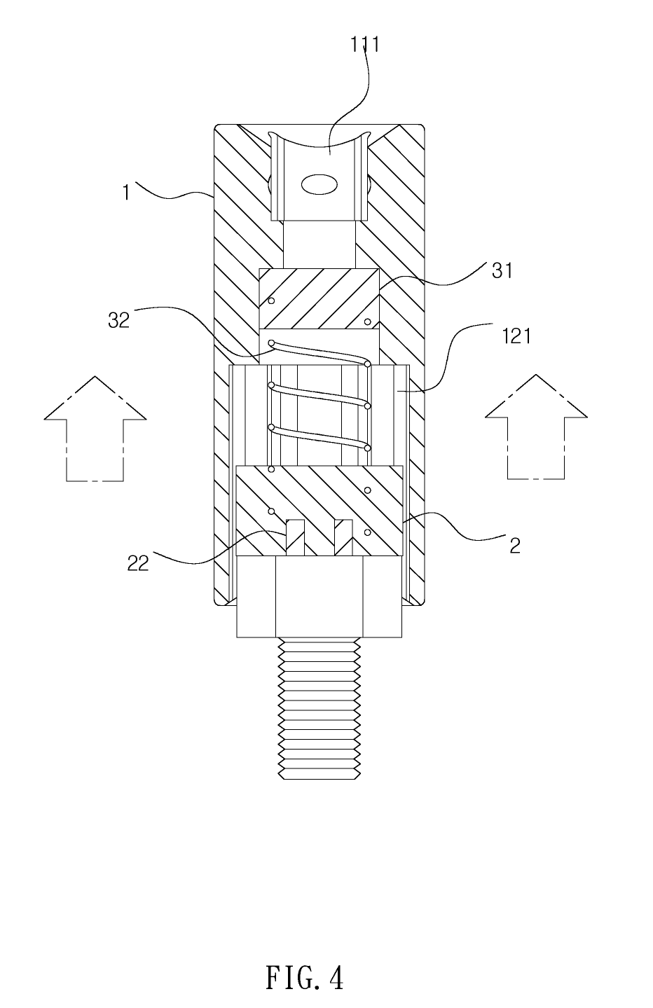

The socket wrench drives the connecting section 11 so that the fitting section 12 screws or removes the fastener element. When the fastener element contacts with the push member 2 to press the spring 32, the push member 2 moves inward the body 1 (as shown in FIG. 3) so that a polygonal portion of the fastener element is completely accommodated in the second polygonal orifice 121, hence the body 1 screw the fastener element. After removing the fastener element, it is magnetically attracted on the push member 2 (as illustrated in FIG. 4) so as to be detachable by user. When the spring 32 is not pressed, it urges the push member 2 reversely so that the push member 2 pushes the fastener element to the rim of second polygonal orifice 121, thus make taking off the fastener element from a socket much easier.

The retainer 31 is integrally formed in the body 1 or a flexible abutting element is retained in the body 1. The spring 32 is connected with the retainer 31 and the push member 2, the retainer 31 has a first locking aperture 311, the push member 2 includes a second locking aperture 21, and the spring 32 is fixed on the first locking aperture 311 and the second locking aperture 21, thus connecting the push member 2, the spring 32, and the retainer 3 together. In another embodiment, the push member 2, the spring 32, and the retainer 3 are connected in any one of an adhering manner, a laser manner, and a spot welding manner. Furthermore, the retainer 31 and the push member 2 can also be injection molded from plastic material so as to be connected with the two ends of the spring 32. Or, each of the retainer 31 and the push member 2 can have a spiral curved to fit with each end of the spring 32.

The push member 2 is polygonal fitting to the first polygonal orifice 121 so as to avoid a rotation of the push member 2 in the second polygonal orifice 121.

When the socket of the present invention going to screw the fastener element into a threaded hole, the head of the fastener element is naturally attracted into the second polygonal orifice by the at least one magnetic attraction element 22, so the socket needs not precisely searching for the fastener element. When removing the fastener element from the threaded hole, the at least one magnetic attraction element 22 magnetically attracts the fastener element together with the movement of the socket wrench, and the push member is reversely pushed by the reverse pushing structure to force the fastener element outward to the rim of the socket, so that the fastener element can be taken out from the socket easily.

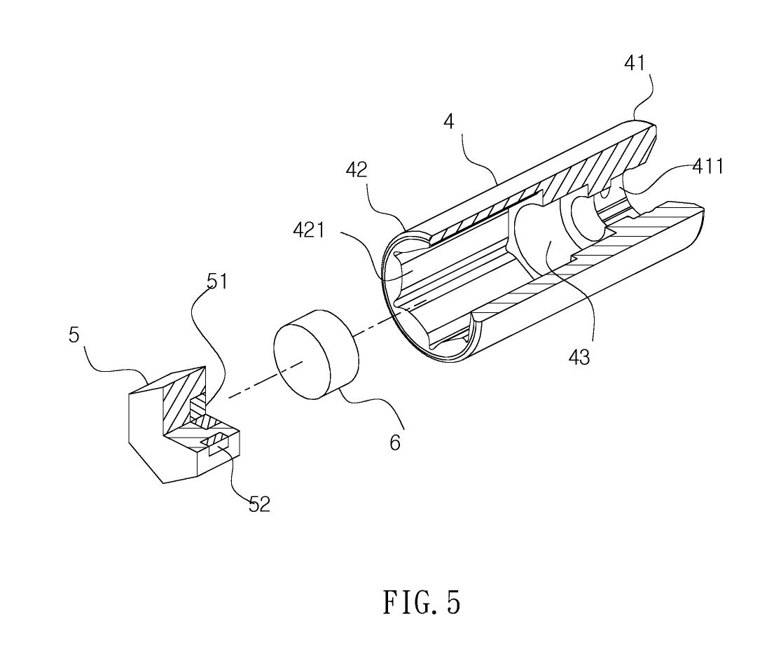

Referring to FIG. 5, a socket according to a second embodiment of the present invention comprises a body 4, a push member 5, and a reverse pushing structure which is a first magnet 6.

The body 4 includes a connecting section 41 and a fitting section 42, the connecting section 41 includes a first polygonal orifice 411 configured to accommodate a socket wrench, and the fitting section 42 includes a second polygonal orifice 421 for driving a fastener element. The body 4 further includes a receiving groove 43 defined therein communicating with the second polygonal orifice 421. The first magnet 6 is accommodated in the receiving groove 43. The push member 5 is movably accommodated in the second polygonal orifice 421 and includes a magnetic attraction element 51 magnetically repelling against the first magnet 6, a second magnet 52 magnetically attracted on an inner wall of the second polygonal orifice 421, wherein a magnetic repulsion force between the first magnet 6 and the magnetic attraction element 51 is more than a magnetic attraction force of the second magnet 52, and when the push member 5 is pushed by the magnetic repulsion force to move toward the rim of the second polygonal orifice 421, a magnetic attraction force between the second magnet 52 and the second polygonal orifice 421 is more than the magnetic repulsion force between the first magnet 6 and the magnetic attraction element 51 and the magnetic attraction force between the magnetic attraction element 51 and the fastener element.

Initially the push member 5 is magnetically attracted by the second magnet 52 in the second polygonal orifice 421, the magnetic attraction force of the second magnet 52 is more than the magnetic repulsion force between the first magnet 6 and the magnetic attraction element 51 to keep the push member 5 on the rim in the second polygonal orifice 421. When the fastener element is pushed by an external force to urge the push member 5 to move into the receiving groove 43, the magnetic repulsion force between the first magnet 6 and the magnetic attraction element 51 increases. After the fastener element is not forced by external force, the push member 5 is pushed outward by the magnetic repulsion force between the first magnet 6 and the magnetic attraction element 51 to move back to the rim of the second polygonal orifice 421, thus the fastener element can be detached from socket easily. At that time the magnetic attraction force of the second magnet 52 with the wall of the socket is firmer than the magnetic attraction force with the fastener element, the push member 5 will not detach when taking off the fastener element.

While various embodiments in accordance with the present invention have been shown and described, it is clear to those skilled in the art that further embodiments may be made without departing from the scope of the present invention.

What is claimed is:

1. A socket comprising: a body, a push member, and a reverse pushing structure; the body including a connecting section and a fitting section, the connecting section having a first polygonal orifice configured to accommodate a socket wrench, and the fitting section having a second polygonal orifice for driving a fastener element; wherein the body includes a receiving groove defined therein communicating with the second polygonal orifice, the push member is movably accommodated in the second polygonal orifice and includes at least one magnetic attraction element; wherein the reverse pushing structure is housed in the receiving groove and configured to push the push member toward the second polygonal orifice rim.

2. The socket as claimed in claim 1, wherein the reverse pushing structure includes a retainer and a spring, the retainer is housed in the receiving groove, and two ends of the spring are connected with the retainer and the push member.

3. The socket as claimed in claim 2, wherein the push member is polygonal fitting to the first polygonal orifice so as to avoid a rotation of the push member.

4. The socket as claimed in claim 1, wherein the reverse pushing structure which is a first magnet, the first magnet is accommodated in the receiving groove and magnetically repels against the magnetic attraction element embedded in the push member, the push member includes a second magnet magnetically attracted on an inner wall of the second polygonal orifice, wherein a magnetic repulsion force between the first magnet and the magnetic attraction element is more than a magnetic attraction force of the second magnet, and when the push member is pushed by the magnetic repulsion force to move onto the rim of the second polygonal orifice, a magnetic attraction force between the second magnet and the second polygonal orifice is more than the magnetic repulsion force between the first magnet and the magnetic attraction element and the magnetic attraction force between the magnetic attraction element and the fastener element.
